(19) United States
(12) Patent Application Publication
(10) Pub. No.: US 2017/0036154 A1
(43) Pub. Date: Feb. 9, 2017

(54) MONITORING OF A PRESSURIZED GAS-BASED CLEANING PROCESS IN A HOSE FILTER INSTALLATION

(71) Applicant: Primetals Technologies Austria GmbH, Linz (AT)

(72) Inventors: Herbert LAUTERBRUNNER, Linz (AT); Martin LEHOFER, Plainsboro, NJ (US); Stefan MAIR, Thal-Assling (AT); Andreas ROHRHOFER, Linz (AT)

(21) Appl. No.: 15/304,357

(22) PCT Filed: Mar. 24, 2015
(86) PCT No.: PCT/EP2015/056177

§ 371 Date: Oct. 14, 2016

(30) Foreign Application Priority Data
Apr. 25, 2014 (EP) 14166050.6

(51) Int. Cl. B01D 46/00; B01D 46/44

(52) U.S. Cl. CPC B01D 46/0068; B01D 46/444

(57) ABSTRACT

A method for monitoring a pressurized gas-based cleaning process in a hose filter installation (2): during a cleaning process, a throughflow (Q) of a pressurized-gas flow during a predefinable time period (T) is determined, a throughflow characteristic (V) is determined using the determined throughflow (Q) of the pressurized-gas flow, and the pressurized gas-based cleaning process is monitored using the throughflow characteristic (V), wherein the throughflow characteristic (V) is a pressurized-gas quantity that has flowed in the predefinable time period (T). A monitoring system (40) for a hose filter installation (2) has at least one throughflow sensor (44) for determining a throughflow (Q) of a pressurized-gas flow, and a control unit (42) for controlling a pressurized gas-based cleaning process, wherein the throughflow sensor (44) is a volume flow sensor or a mass flow sensor, and the control unit (42) is set up for carrying out the method.

### CROSS-REFERENCE TO RELATED APPLICATIONS

The present application is a 35 U.S.C. §§371 national phase conversion of PCT/EP2015/056177, filed Mar. 24, 2015, which claims priority of European Patent Application No. 14166050.6, filed Apr. 25, 2014, the contents of which are incorporated by reference herein. The PCT International Application was published in the German language.

The invention relates to a method for monitoring a pressurized gas-based cleaning process in a hose filter installation. The invention further relates to a monitoring system for a hose filter installation, having at least one throughflow sensor for determining a throughflow of a pressurized gas flow and a control unit for controlling a pressurized gas-based cleaning process. The invention furthermore relates to a hose filter installation with a plurality of hose filters.

### TECHNICAL BACKGROUND

In several industrial processes, in particular in metallurgical processes, exhaust gases are produced, which contain large quantities of dust particles. For reasons of environmental protection, such exhaust gases must be dedusted before they are released into the atmosphere.

Several methods are known for dedusting an exhaust gas. Generally, these methods can be assigned to one of the four types of dedusting: mechanical dedusting, electro dedusting, wet dedusting or filtration- or respectively dry dedusting.

In mechanical dedusting, the gravity, inertia force and/or centrifugal force of the dust particles is utilized, in order to separate the dust particles from the exhaust gas.

Electro dedusting is based on the principle that electrically charged dust particles in an electrical field are attracted and bonded by an oppositely charged electrode.

Wet dedusting makes provision to bring the exhaust gas, containing dust, in contact with a washing fluid, in which the dust particles are bonded, whereby the dust particles are removed from the exhaust gas.

In filtration dedusting, the exhaust gas, containing dust, strikes onto a filter, which holds back the dust particles and allows the dedusted exhaust gas through.

Filtration dedusting is distinguished by a high dedusting efficiency. Typically, in filtration dedusting, more than 99% of the dust particles are filtered out from the exhaust gas. In several industrial fields, filtration dedusting is therefore given preference compared to the other types of dedusting.

The dedusting/filtration takes place in filtration dedusting usually by means of a hose filter installation which comprises a plurality of hose filters (up to several thousand). The exhaust gas, containing dust, which is to be cleaned is introduced into the hose filter installation. The exhaust gas then flows into the hose filters. In so doing, the dust particles are stored on a surface of the respective hose filter or respectively on a surface of a particle layer forming/growing on the hose filter (the so-called filter cake).

The exhaust gas which is cleaned in this way then flows out from the respective hose filter.

With an increasing filter cake thickness, a flow resistance for the exhaust gas increases. As with an increasing flow resistance an exhaust gas throughput of the hose filter installation decreases, the hose filters are cleaned at a predefined filter cake thickness. In this way, as high an exhaust gas throughput as possible and as high a dedusting efficiency as possible can be ensured even in the case of a long operating duration of the hose filter installation.

Several methods are known for the cleaning of hose filters. The so-called pressure surge method (pulse jet cleaning) has largely become accepted as the standard, inter alia because in this method the cleaning of the hose filters, compared to other known methods, is very effective and the dedusting/filtration process does not have to be interrupted for the cleaning.

In the pressure surge method, the hose filters are cleaned by means of a pressurized gas. Here, a short (ca. 0.1 s long) pressure surge is generated in each case in the hose filters by means of the pressurized gas. Such a pressure surge spreads out in the longitudinal direction of the respective hose filter and in so doing expands the hose filter in a wave-like manner transversely to the longitudinal direction, whereby the filter cake is detached from the hose filter.

To generate the pressure surges, the pressurized gas is directed from pressurized gas reservoirs by means of pressurized gas lines to the hose filters and is introduced into the hose filters. The introducing of the pressurized gas is controlled here using valves which are arranged in the pressurized gas lines.

In order to ensure as high an exhaust gas throughput as possible and as high a dedusting efficiency of the hose filter installation as possible, the hose filters must be cleaned as intended. If the cleaning and/or an efficiency of the cleaning is impaired, e.g. due to a defect of an element of the hose filter installation, the exhaust gas throughput and the dedusting efficiency of the hose filter installation are reduced. Therefore, it is usual in hose filter installations to monitor such a pressurized gas-based cleaning process, in order to be able to detect and if applicable eliminate a possible impairment to the cleaning.

A known monitoring method makes provision to detect and evaluate a stream flow in the respective valve. This monitoring method indeed permits a conclusion concerning an electrical state and/or an electrical behavior of the valve. For example, it can be established whether a cable break or a short-circuit is present. However, this monitoring method does not permit any conclusion concerning a mechanical state and/or a mechanical behavior of the valve or of further elements of the hose filter installation. With this monitoring method, therefore, mechanical damage to the hose filter installation is not detected. Furthermore, this monitoring method is complex/cost-intensive, because each valve has to be monitored individually.

Another monitoring method provides a manual acoustic diagnosis of a cleaning shock which is generated on the production of the pressure surge, by operating personnel. Here, the operating personnel listens to the cleaning shock and decides, on the basis of empirical values, whether the cleaning has taken place correctly. Owing to a lack of objectivity of empirical values and of human perception, this monitoring method is not reliable. In addition, this monitoring method involves a great expenditure of time/effort for the operating personnel, because a hose filter installation comprises a plurality of hose filters which must be monitored sequentially during an operation of the hose filter installation. Furthermore, in many hose filter installations, it is prohibited, due to safety regulations, to enter these during operation, so that this monitoring method cannot be applied at all.

In a further monitoring method, an acoustic diagnosis of such a cleaning shock is carried out in an automated manner, wherein the cleaning shock is received and evaluated by means of an acoustic sensor. This monitoring method has the disadvantage that a plurality of such acoustic sensors and associated data lines is necessary for monitoring all of the hose filters. Therefore, a system for carrying out this monitoring method is complex in its installation and also cost-intensive. Indirectly, therefore, the monitoring method is also cost-intensive.

### SUMMARY OF THE INVENTION

It is an object of the invention to provide a method for favorably monitoring, in terms of effort and cost, a pressurized gas-based cleaning process in a hose filter installation and a monitoring system and a hose filter installation for carrying out the method.

This problem is solved according to the invention by a method, a monitoring system and a hose filter installation having the features disclosed herein. Advantageous configurations/further developments are the subject of the following description of both a method and a monitoring system and/or a hose filter installation.

The method according to the invention makes provision that in a cleaning process, during a predefinable time period, a throughflow of a pressurized gas flow is determined, then using the determined throughflow of the pressurized gas flow, a throughflow characteristic is determined, and then using the throughflow characteristic, the pressurized gas-based cleaning process is monitored. The throughflow characteristic here is a pressurized gas quantity that has flowed in the predefinable time period.

An advantage of the method is that it enables an automated monitoring of a pressurized gas-based cleaning process. It is therefore possible to carry out the method quickly and reliably. A further advantage is that a number of items of equipment/devices, which are required for carrying out the method, is not coupled to a number of valves and/or hose filters of the hose filter installation.

As pressurized gas, a gas/gas mixture can be considered, which has a gas pressure which is greater than atmospheric pressure. Preferably, the pressurized gas has a gas pressure of a few bar. In production and/or processing of the pressurized gas, e.g. a compressor can come into use. The pressurized gas can consist of nitrogen, carbon dioxide and/or another gas, in particular an inert gas, and/or can contain these gases in addition to one or more further gases. Advantageously, the pressurized gas is pressurized air, because pressurized air is able to be produced in a favorable manner with regard to effort/cost.

The throughflow of the pressurized gas flow can be understood to mean a volume/mass flow of the pressurized gas flow in a flow guiding element, such as e.g. a pressurized gas line.

The determining of the throughflow can take place using a throughflow sensor. Expediently, the throughflow sensor generates a signal (“throughflow signal”), which corresponds to the determined throughflow.

Expediently, the cleaning process comprises a cleaning at least of one hose filter of the hose filter installation. Preferably, in the cleaning process, a hose filter group of the hose filter installation is cleaned.

A group of hose filters can be considered as a hose filter group, in which the hose filters are able to be supplied simultaneously with a pressurized gas, in particular using a shared valve for controlling a pressurized gas supply to the hose filters.

Furthermore, it is possible that in the cleaning process, in so-called simultaneous operation, a plurality of hose filter groups is cleaned simultaneously.

In a preferred manner, different hose filter groups of the hose filter installation are cleaned sequentially, i.e. one after another, in respectively a distinct cleaning process. In addition, the hose filter groups are preferably cleaned cyclically. A cleaning cycle can comprise a sequential cleaning of all hose filter groups of the hose filter installation in respectively a distinct cleaning process. At the end of the cleaning cycle, a further or a plurality of further such cleaning cycles can take place.

Furthermore, it is also possible that the hose filters and/or hose filter groups are cleaned individually as a function of their respective degree of contamination, instead of according to a cleaning cycle.

The predefinable time period can be predefined such that the determining of the throughflow characteristic is started simultaneously with the beginning of the cleaning process or with a predefinable time delay after the beginning of the cleaning process.

Furthermore, the predefinable time period is expediently predefined such that the determining of the throughflow characteristic is ended at the latest when a further cleaning process, following chronologically after the cleaning process, is begun.

Expediently, the throughflow characteristic is a derivative of the throughflow. A quantity derived from the throughflow and/or dependent on the throughflow can be regarded as a derivative of the throughflow.

Expediently, the pressurized gas quantity that has flowed in the predefinable time period is a mass or a volume of the pressurized gas that has flowed in the predefinable time period through a flow guiding element.

The pressurized gas quantity that has flowed in the predefinable time period can be understood as a mass or a volume of the pressurized gas that has flowed in the predefinable time period through a flow guiding element, e.g. a pressurized gas line. The time behavior of the throughflow can be e.g. a chronological rate of change of the throughflow.

Furthermore, the throughflow characteristic can comprise an individual value or a plurality of values. Such a plurality of values can represent e.g. a progression, in particular a chronological progression, of a derivative of the throughflow.

The throughflow characteristic can be determined inter alia by an integrating, a deriving and/or a Fourier analysis of the throughflow. Furthermore, the determining of the throughflow characteristic can comprise further steps. Thus, e.g. the determining of the throughflow characteristic can comprise a filtering of the throughflow signal generated by the throughflow sensor, in particular using a high-, low- and/or band-pass filter.

Furthermore, the cleaning process can comprise a filling at least of a pressurized gas reservoir during a filling time period. The filling can take place e.g. using a compressor. The time period in which the pressurized gas is introduced into the pressurized gas reservoir, in order to fill it, can be regarded as the filling time period.

It is expedient if the pressurized gas reservoir is filled using the pressurized gas flow, the throughflow of which is determined. Thereby, using the throughflow, a pressurized gas quantity introduced into the pressurized gas reservoir during the cleaning process can be determined. Furthermore, it is expedient if the predefinable time period lies within the filling time period.

The monitoring can comprise a comparing of the determined throughflow characteristic with at least one predefined reference throughflow characteristic. Such a reference throughflow characteristic can be e.g. an upper/lower limit for the throughflow characteristic.

The reference throughflow characteristic can depend on how many hose filters/hose filter groups are cleaned simultaneously during the cleaning process. If e.g. during the cleaning process two hose filters/hose filter groups are cleaned simultaneously, the reference throughflow characteristic can be twice as great as for the case where during the cleaning one hose filter/one hose filter group is cleaned.

The reference throughflow characteristic can, in addition, depend on when the hose filter/the hose filter group is cleaned within the cleaning cycle.

Expediently, during the monitoring an error message is issued if the determined throughflow characteristic meets a predefined condition with regard to the reference throughflow characteristic. The predefined condition can comprise a mathematical relation between the determined throughflow characteristic and the reference throughflow characteristic.

Thus, the predefined condition can be such that an error message is issued when the determined throughflow characteristic is greater, less than or equal to the reference throughflow characteristic.

In a preferred manner, during the cleaning process at least one pressure surge is generated. The cleaning process can therefore be embodied as a pressure surge cleaning. Expediently, at least one pressure surge is generated in each hose filter which is cleaned during the cleaning process.

Furthermore, the method according to the invention and/or at least one of the developments described further above can be used for the detection of a hose filter installation defect, in particular of a defect of a valve, of a pressurized gas line and/or of a hose filter. Here, expediently, the throughflow characteristic is compared with at least one predefined reference throughflow characteristic, which represents an intact hose filter installation, in particular an intact valve, an intact pressurized gas line and/or an intact hose filter. Expediently, such a reference throughflow characteristic is received previously during a cleaning in the case of an intact hose filter installation under predefined conditions.

Alternatively, it is possible that the reference throughflow characteristic represents a defective hose filter installation. In such a case, the reference throughflow characteristic is expediently received previously during a cleaning in the case of a defective hose filter installation, in particular prepared in a predefined manner with a defect. In particular, several reference throughflow characteristics can be previously received, wherein in each of these receptions of the reference throughflow characteristics respectively a different hose filter installation defect can be present. Thereby, a possible hose filter installation defect can be assigned to each of these several reference throughflow characteristics.

The previously mentioned error message can contain inter alia one or more suggestions as to which type of defect, e.g. a defect of a valve, of a pressurized gas line and/or of a hose filter, could be present. Expediently, it can be derived, from the comparison of the throughflow characteristic with the reference throughflow characteristic, which type of defect is present.

In addition, the error message can contain a clear identification of an element/component of the hose filter installation which is suspected of being defective. In this way, the element/component can be investigated in a targeted manner in respect of its functional capability during maintenance/repair work and can be exchanged/repaired if necessary.

It is possible to carry out the method according to the invention, and/or at least one of the developments described further above, in a plurality of such cleaning processes. In a preferred manner, in several, in particular in all, of these cleaning processes respectively such a throughflow characteristic is determined. Using the throughflow characteristics a trend analysis can be carried out, in which preferably at least one trend model is established.

The trend analysis can comprise an extrapolation for predicting the throughflow characteristic in future/subsequent cleaning processes.

Expediently, with each cleaning process, the respectively determined throughflow characteristic is stored in a data memory, so that during the trend analysis, throughflow characteristics of previous cleaning processes can be referred back to.

For the early detection of a hose filter installation defect, in particular of a defect of a valve, of a pressurized gas line and/or of a hose filter, using the trend model it can be determined how many cleaning processes are able to be carried out until such a hose filter installation defect occurs.

Furthermore, a warning message can be issued when a number of the cleaning processes which are still able to be carried out, until such a hose filter installation defect occurs, is less than a predefined number. The warning message can contain a clear identification of an element/component of the hose filter installation in which such a hose filter installation defect is imminent. In this way, the element/component can be exchanged or repaired in a targeted manner during maintenance/repair work.

The monitoring system according to the invention has at least one throughflow sensor for determining a throughflow of a pressurized gas flow and a control unit for controlling a pressurized gas-based cleaning process, wherein the throughflow sensor is a volume flow sensor or a mass flow sensor and wherein the control unit is set up for carrying out the method according to the invention and/or for carrying out at least one of the developments described further above. Expediently, the throughflow sensor is set up to provide a throughflow signal which corresponds to the determined throughflow of the pressurized gas flow. Furthermore, it is expedient if the throughflow sensor is set up for data transmission, in particular for the transmission of the throughflow signal, to the control unit. The data transmission can take place wirelessly, e.g. by radio technology, or in a wired manner, e.g. via an electric line or a fiber optic cable.

The control unit can be embodied e.g. as a programmable computer. Furthermore, the control unit can have a data memory, in particular for storing at least one throughflow characteristic and/or at least one reference throughflow characteristic. Expediently, at least one reference throughflow characteristic is stored in the control unit, in particular in the data memory. In the control unit, in addition, an evaluation algorithm can be stored.

The evaluation algorithm can be set up for calculating a throughflow characteristic, in particular using the throughflow signal. Furthermore, the evaluation algorithm can be set up to compare the throughflow characteristic with the reference throughflow characteristic. In addition, the evaluation algorithm can be set up for carrying out a trend analysis, wherein in the trend analysis preferably at least one trend model is established.

Furthermore, the monitoring system can be configured as a condition monitoring system. Preferably, the control unit is set up for conveying a message, in particular an error message, to a display/operating unit. Expediently, the control unit is set up for data transmission, in particular for the transmission of the message, to the display/operating unit. The data transmission can take place here wirelessly, e.g. by radio technology, or in a wired manner, e.g. via an electric line or a fiber optic cable.

The message can be transmitted to the display/operating unit inter alia in the form of an email or SMS.

The display/operating unit can be a mobile device, e.g. a smartphone, a tablet computer or a notebook. Furthermore, the display/operating unit can, however, also be a stationary device, such as e.g. a stationary screen or a stationary computer. Such a stationary display/operating unit can be a component of the monitoring system.

The hose filter installation according to the invention is equipped with such a monitoring system.

Furthermore, the hose filter installation is expediently equipped with at least one pressurized gas reservoir. The pressurized gas reservoir can be embodied e.g. as a gas container. Furthermore, it is expedient if the hose filter installation has at least one pressurized gas line for supplying the pressurized gas reservoir with a pressurized gas. The previously mentioned throughflow sensor of the monitoring system is advantageously arranged in such a pressurized gas line. This makes it possible to determine a throughflow of a pressurized gas flow, by means of which the pressurized gas reservoir is filled.

In a preferred manner, the hose filter installation is equipped with a plurality of pressurized gas reservoirs. Moreover, the hose filter installation preferably has a main pressurized gas line for supplying the plurality of pressurized gas reservoirs with the pressurized gas.

The main pressurized gas line can be understood here to mean a pressurized gas line which is connected at a first side (outlet side) with a plurality of further pressurized gas lines and for supplying these further pressurized gas lines with the pressurized gas. The further pressurized gas lines can in turn be provided for supplying the plurality of pressurized gas reservoirs with the pressurized gas, wherein each of the plurality of pressurized gas reservoirs can be connected with respectively one of the further pressurized gas lines. On a second side (inlet side), the main pressurized gas line can be connected with a compressor.

Preferably, the previously mentioned throughflow sensor of the monitoring system is arranged in the main pressurized gas line. Thereby, it is possible, without further throughflow sensors in each pressurized gas flow, by means of which any one of the plurality of pressurized gas reservoirs is filled, to determine a throughflow of one. This is because each pressurized gas flow, by means of which any one of the plurality of pressurized gas reservoirs is filled, flows initially through the main pressurized gas line, before the pressurized gas flow flows into the respective pressurized gas reservoir.

Although in the description and/or in the claims some terms are used respectively in the singular or in connection with a particular numeral, the scope of the invention for these terms is not to be restricted to the singular or to the respective numeral. Furthermore, the words “a” and/or “an” are not to be understood as numerals, but rather as indefinite articles.

The description of advantageous configurations given hitherto contains numerous features which are reproduced. These features can, however, also expediently be regarded individually and combined to form expedient further combinations. In particular, these features are able to be combined respectively individually and in any suitable combination with the method according to the invention and with the devices according to the invention.

The characteristics, features and advantages of the invention, described above, and also the manner in which these are achieved, will become more clearly and distinctly understandable in connection with the following description of the example embodiment, which is explained in further detail in connection with the drawings. The example embodiment serves to explain the invention and does not restrict the invention to the combination of features indicated therein, also not in regard to functional features. In addition, features of the example embodiment suited thereto can also be regarded in an explicitly isolated manner and/or can be combined.

### BRIEF DESCRIPTION OF THE DRAWINGS

There are shown:

FIG. 1 a hose filter installation with a plurality of hose filters and with a monitoring system; and

FIG. 2 a diagram, in which an example chronological progression of a throughflow and of a throughflow characteristic are illustrated in two successive cleaning processes.

### DESCRIPTION OF AN EMBODIMENT

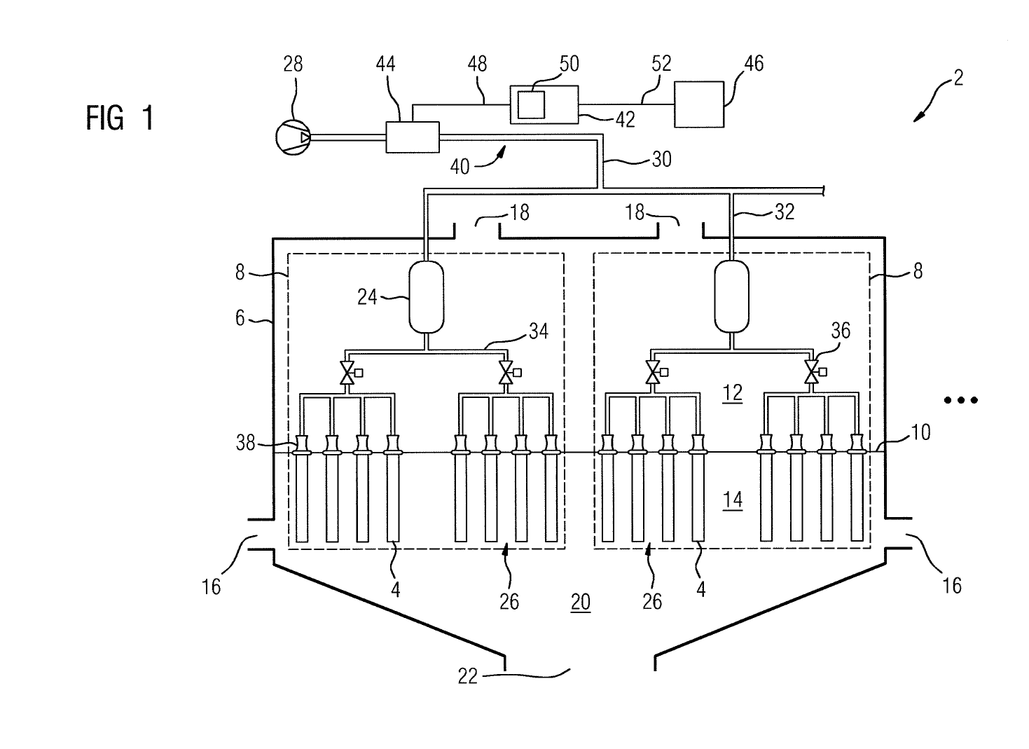

FIG. 1 shows diagrammatically a hose filter installation 2 with a plurality of hose filters 4. The hose filter installation 2 comprises several filter chambers 6, which in the present example are respectively divided into two chamber segments 8. Basically, it is also possible that the filter chambers 6 comprise respectively only one chamber segment 8 or are divided into more than two chamber segments 8. For the sake of clarity, in FIG. 1 only one of the several filter chambers 6 is illustrated by way of example.

In each of the filter chambers 6 respectively a perforated plate 10 is arranged, at the holes of which the hose filters 4 are arranged, and which divides the filter chamber 6 into a clean gas space 12 and a crude gas space 14. The crude gas space 14 contains an exhaust gas which is to be cleaned in a dust-containing state, whereas the clean gas space 12 contains the exhaust gas after its dedusting, i.e. in a substantially dust-free state.

The filter chambers 6 have respectively two exhaust gas inlets 16 for introducing an exhaust gas, which is to be dedusted, into the chamber segments 8. In addition, the filter chambers 6 have respectively two exhaust gas outlets 18 for directing the exhaust gas out after its dedusting. Here, at each chamber segment 8 an exhaust gas inlet 16 and an exhaust gas outlet 18 are arranged. Furthermore, the filter chambers 6 comprise respectively a dust collecting space 20, in which dust removed from the exhaust gas can collect, and a dust outlet 22 for discharging the dust from the dust collecting space 20.

In the filter chambers 6 respectively eight of the hose filters and one pressurized gas reservoir 24, embodied as a gas container, filled with a pressurized gas, are arranged, wherein the eight hose filters 4 are divided into two hose filter groups 26 with in each case four hose filters 4. In the present example embodiment, the pressurized gas is pressurized air.

The hose filter installation 2 is, moreover, equipped with a compressor 28, which is connected with a main pressurized gas line 30. The main pressurized gas line 30 in turn is connected with other pressurized gas lines 32, each of which is respectively connected with one of the pressurized gas reservoirs 24. By means of the compressor 28, the pressurized gas can therefore be refilled into the pressurized gas reservoir 24.

The hose filters 4 are able to be supplied with the pressurized gas by means of further pressurized gas lines 34, which are connected with the pressurized gas reservoirs 24. Here, the hose filter groups 26 arranged in a shared chamber segment 8 are able to be supplied with the pressurized gas from a shared pressurized gas reservoir 24.

For controlling a pressurized gas supply to the hose filters 4, respectively a valve 36 is provided, arranged in such a further pressurized gas line 34, for each hose filter group 26. The valves 36 are diaphragm valves, which are able to be controlled electrically. The individual hose filters 4 of the respective hose filter groups 26 are able to be supplied simultaneously with the pressurized gas by means of such a valve 36.

Between the hose filters 4 and the further pressurized gas lines 34 a venturi nozzle 38 is respectively arranged, which is provided to add to a pressurized gas flow, which is controlled by the respective valve 36, for amplification additionally ambient air or another gas/gas mixture, before the pressurized gas flow is introduced into the corresponding hose filter 4.

In the present example embodiment, the hose filter installation 2 comprises per filter chamber 6 a smaller number of valves 36, a smaller number of pressurized gas reservoirs 24, and a smaller number of hose filters 4 than a typical industrial hose filter installation. The smaller number of the respective elements serves merely for the clarity of FIG. 1 and is not intended to restrict the invention to precisely this number.

Furthermore, the hose filter installation 2 comprises a monitoring system 40 with a control unit 42 for controlling a pressurized gas-based cleaning process of the hose filters 4, with a throughflow sensor 44 for determining a throughflow of a pressurized gas flow and with a display/operating unit 46.

The throughflow sensor 44 is arranged in the main pressurized gas line 30 and in the present example embodiment is embodied as a volume flow sensor. Alternatively, the throughflow sensor 44 could be embodied as a mass flow sensor. Furthermore, the throughflow sensor 44 is set up to provide a throughflow signal, which corresponds to the determined throughflow, and to transmit this throughflow signal to the control unit 42. The transmission of the throughflow signal takes place via a data line 48, by which the throughflow sensor 44 is connected with the control unit 42.

The control unit 42 is embodied as a programmable computer. Furthermore, the control unit 42 has a data memory 50, into which two reference throughflow characteristics—a predefined upper limit and a predefined lower limit for the throughflow characteristic—are stored. An interval defined by the two reference throughflow characteristics represents an intact state of the hose filter installation 2.

Furthermore, an evaluation algorithm is stored in the control unit 42. The evaluation algorithm is set up to calculate a throughflow characteristic from the throughflow signal. In addition, the evaluation algorithm is set up to compare the throughflow characteristic with the two reference throughflow characteristics and to carry out a trend analysis for the throughflow characteristic.

Furthermore, the control unit 42 is set up to transmit an error/warning message to the display/operating unit 46. The transmission of the message takes place via a further data line 52, by way of which the control unit 42 is connected with the display/operating unit 46. In the present example embodiment, the display/operating unit 46 is a stationary computer.

Moreover, the control unit 42 is connected by additional data lines to the valves 36 and is set up for controlling the valves 36. For the sake of clarity, these additional data lines are not illustrated in FIG. 1.

In order to start a cleaning process of one of the hose filter groups 26, the valve 36 is opened which is provided for controlling a pressurized gas supply to this hose filter group 26. For this, a corresponding control signal is transmitted to the valve 36 by the control unit 42.

The pressurized gas flows through the opened valve 36, out of the pressurized gas reservoir 24 provided for the pressurized gas supply of the hose filter group 26, to the venturi nozzles of the hose filter group 26. The pressurized gas is introduced through the venturi nozzles 38 into the individual hose filters 4 of the hose filter group 26, wherein by means of the venturi nozzles 38 the cleaned exhaust gas, present in the clean gas space 12, is added to the pressurized gas. Thereby, a pressure surge is produced in the respective hose filter 4, which spreads out in the longitudinal direction of the hose filter 4 and expands the hose filter 4 in a wave-like manner transversely to the longitudinal direction, whereby a filter cake stored on the hose filter 4 is detached from the hose filter 4 and the hose filter 4 is therefore cleaned.

During this process, by means of the compressor 28 a pressurized gas flow, flowing to the pressurized gas reservoir 24, is produced, by means of which the pressurized gas reservoir 24 is filled again over a filling time period.

Furthermore, by means of the throughflow sensor 44, during a predefinable time period, a throughflow of this pressurized gas flow is determined, wherein the predefinable time period is predefined such that it lies within the filling time period. In the present example, the throughflow is a volume flow of the pressurized gas flow. The throughflow sensor generates a throughflow signal which corresponds to the determined throughflow and transmits this throughflow signal to the control unit 42.

The evaluation algorithm of the control unit 42 determines/calculates a throughflow characteristic by an integrating of the throughflow signal (and therefore indirectly of the throughflow) over the predefinable time period. The throughflow characteristic is then stored in the data memory 50 of the control unit 42. In the present example, the throughflow characteristic is a throughflow quantity that has flowed through the main pressurized gas line 30 in the predefinable time period. This throughflow quantity is, simultaneously, the throughflow quantity which is refilled in the predefinable time period into the pressurized gas reservoir 24 and/or is consumed during the cleaning process.

The throughflow characteristic is compared by the control unit 42 with a first reference throughflow characteristic (the upper limit for the throughflow characteristic) and a second reference throughflow characteristic (the lower limit for the throughflow characteristic).

If the throughflow characteristic is greater than the first reference throughflow characteristic (upper limit) or smaller than the second reference throughflow characteristic (lower limit), an error message is emitted to the display/operating unit 46.

The error message contains one or more suggestions for hose filter installation defects which are possibly present, which are the cause of the throughflow characteristic being greater than the first reference throughflow characteristic (upper limit) or respectively smaller than the second reference throughflow characteristic (lower limit).

For the case where the throughflow characteristic is greater than the first reference throughflow characteristic (upper limit), and therefore the pressurized gas quantity consumed during the cleaning process is greater than planned, such a suggestion can be e.g. that a hose filter 4 has a crack, a valve 36 cannot be closed properly and/or a pressurized gas line 30, 32, 34 has a leak.

For the case where the throughflow characteristic is smaller than the second reference throughflow characteristic (lower limit), and therefore the pressurized gas quantity consumed during the cleaning process is less than planned, such a suggestion can be e.g. that a valve 36 cannot be opened properly.

In addition, the error message contains a clear identification of the filter group 26 which is cleaned during the cleaning process, so that the hose filters 4 of this filter group 26 and/or other elements of the hose filter installation 2 which are functionally connected with the filter group 26 can be investigated by the operating personnel in a targeted manner as regards their functional capability.

In order to terminate the cleaning process, the valve 36, which is provided for controlling the pressurized gas supply to the cleaned hose filter group 26, is closed. For this, a corresponding control signal is transmitted to the valve 36 by the control unit 42.

After termination of the cleaning process, a counter for calculating the throughflow characteristic in the evaluation algorithm is reset or set to zero.

A cleaning of the hose filter installation 2 is carried out sequentially. This means that after termination of the cleaning process of the hose filter group 26, in a further cleaning process another hose filter group 26 of the hose filter installation 2 is cleaned.

Furthermore, the hose filter groups 26 are cleaned cyclically. A cleaning cycle comprises a sequential cleaning of all hose filter groups 26 of the hose filter installation 2. After the cleaning cycle has elapsed, further such cleaning cycles are carried out.

With each cleaning process, such a throughflow characteristic is determined and is stored in the data memory 50 of the control unit.

Using the throughflow characteristics stored in the data memory 50, a trend analysis is carried out, in which for each hose filter group 26 respectively a trend model is established. The trend models are used respectively for an extrapolation for predicting the throughflow characteristic in future/subsequent cleaning processes of the respective hose filter group 26. In this way, it is estimated how many cleaning processes are able to be carried out until the throughflow characteristic is greater than the first reference throughflow characteristic (upper limit) or respectively is smaller than the second reference throughflow characteristic (lower limit) and therefore a hose filter installation defect could be present.

Furthermore, a warning message is transmitted by the control unit 42 to the display/operating unit 46 when an estimated number of the cleaning processes which are still able to be carried out until the throughflow characteristic is greater than the first reference throughflow characteristic (upper limit) or respectively smaller than the second reference throughflow characteristic (lower limit). Thereby, operating personnel can carry out a maintenance of the hose filter installation 2 before such a hose filter installation defect or even a total failure of an element of the hose filter installation 2 is present.

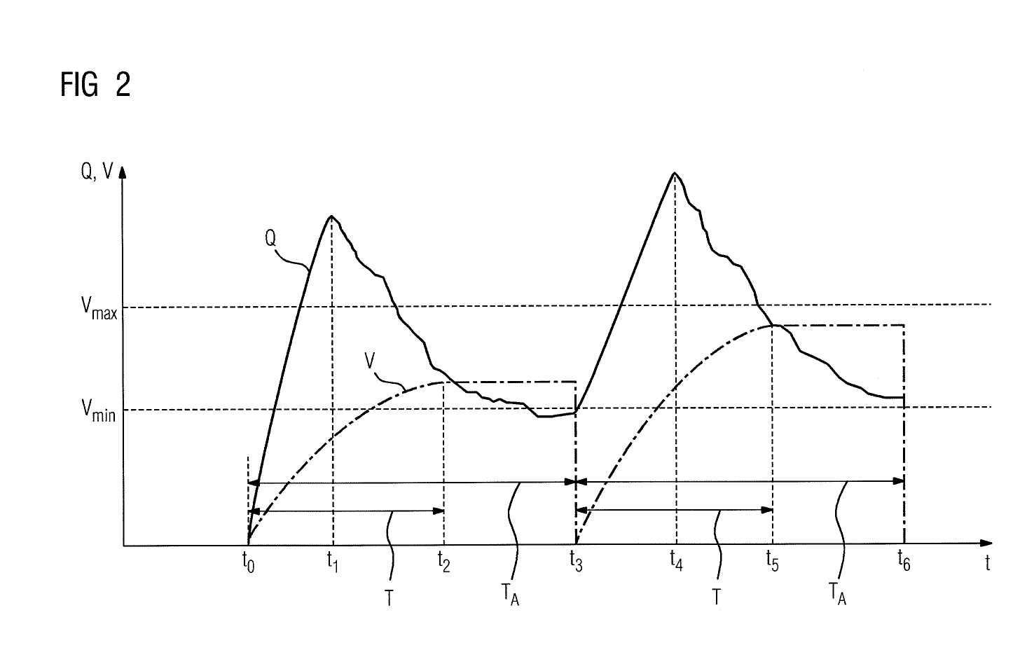

FIG. 2 shows a qualitative diagram in which there are illustrated an example chronological progression of the throughflow Q determined by means of the throughflow sensor 44 and of the throughflow characteristic V determined from the throughflow Q in two successive cleaning processes.

On the x-axis of the diagram a time t is plotted and on the y-axis of the diagram the throughflow Q and the throughflow characteristic V are plotted.

The diagram comprises two horizontal dashed lines. The upper of these two lines represents the first reference throughflow characteristic Vₘₐₓ (upper limit) and the lower of these two lines represents the second reference throughflow characteristic Vₘᵢₙ (lower limit).

At a point in time t₀ a first cleaning process is started, in which one of the hose filter groups 26 is cleaned, as described above. For a generating of the pressure surges in the individual hose filters 4 of the hose filter group 26, the pressurized gas is consumed from a pressurized gas reservoir 24, whereby a gas pressure in the pressurized gas reservoir 24 decreases. During the first cleaning process, by means of the compressor 28 a pressurized gas flow flowing to the pressurized gas reservoir 24 is generated, by means of which the pressurized gas reservoir 24 is filled again.

From the point in time t₀ up to a point in time t₁ the throughflow Q increases beginning at zero. From the point in time t₁ up to a point in time t₃, at which the first cleaning process is terminated, the throughflow Q decreases. This is because starting from the point in time t₁ the gas pressure in the pressurized gas reservoir 24 is again approximately as great as before the start of the first cleaning process, so that per unit of time a smaller pressurized gas quantity flows from the compressor 28 to the pressurized gas reservoir 24 than before the point in time t₁, as the gas pressure is less.

The pressurized gas reservoir 24 is filled during the entire first cleaning process. A filling time period T_{A} of the first cleaning process therefore comprises the entire timespan from the point in time t₀ up to the point in time t₃.

The throughflow characteristic V is determined by an integrating of the throughflow Q over the predefinable time period T. The predefinable time period T is predefined such that the determining of the throughflow characteristic V starts simultaneously with the first cleaning process, i.e. at the point in time t₀, and ends at a point in time t₂, which lies before the end of the first cleaning process (at the point in time t₃).

In the predefinable time period T, i.e. as long as the determining of the throughflow characteristic V is not completed, an instantaneous value of the throughflow characteristic V increases monotonically. Starting from the point in time t₂, i.e. as soon as the determining of the throughflow characteristic V is completed, the throughflow characteristic V remains constant up to the end of the first cleaning process. In the first cleaning process, the throughflow characteristic V, as soon as its determining is completed, lies between the first reference throughflow characteristic Vₘₐₓ and the second reference throughflow characteristic Vₘᵢₙ.

At the point in time t₃, i.e. immediately after the first cleaning process, a second cleaning process is started, in which another of the hose filter groups 26 is cleaned using the same pressurized gas reservoir 24. From the point in time t₃ up to a point in time t₄ the throughflow Q increases. Starting from the point in time t₄ up to a point in time t₆, at which the second cleaning process is terminated, the throughflow Q decreases.

In an analogous manner to the first cleaning process, the pressurized gas reservoir 24 is filled during the entire second cleaning process, wherein the second cleaning process in the present example comprises an identical duration to the first cleaning process. The filling time period T_{A} therefore comprises the entire timespan from the point in time t₃ up to the point in time t₆. Basically, however, it is also possible to provide different durations for the individual cleaning processes.

Also in the second cleaning process, the throughflow characteristic V is determined by an integrating of the throughflow Q over the same predefinable time period T. In an analogous manner, the predefinable time period T in the second cleaning process is predefined such that the determining of the throughflow characteristic V starts simultaneously with the second cleaning process, i.e. at the point in time t₃, and ends at a point in time t₅, which lies before the end of the second cleaning process (at the point in time t₆).

Unlike in the first cleaning process, the throughflow Q at the start of the second cleaning process is greater than zero, which is due to the fact that the pressurized gas flow from the first cleaning process at the point in time t₃ has not yet completely subsided. Consequently, the throughflow characteristic V determined in the second cleaning process is greater than in the first cleaning process. If one were to provide such a great chronological distance between the cleaning processes that the throughflow Q were to have already subsided to zero at the beginning of the second cleaning process, the through-flow characteristic V in the second cleaning process could be equal in extent to that in the first cleaning process.

Also in the second cleaning process, the throughflow characteristic V, as soon as its determining is completed (i.e. starting from the point in time t₅), lies between the first reference throughflow characteristic Vₘₐₓ and the second reference throughflow characteristic Vₘᵢₙ.

Although the invention has been further illustrated and described in detail through the preferred example embodiment, the invention is not restricted by the disclosed example, and other variations can be derived herefrom without departing from the scope of protection of the invention.

### LIST OF REFERENCE SIGNS

2 hose filter installation
4 hose filter
6 filter chamber
8 chamber segment
10 perforated plate
12 clean gas space
14 crude gas space
16 exhaust gas inlet
18 exhaust gas outlet
20 dust collecting space
22 dust outlet
24 pressurized gas reservoir
26 hose filter group
28 compressor
30 main pressurized gas line
32 pressurized gas line
34 pressurized gas line
36 valve
38 venturi nozzle
40 monitoring system
42 control unit
44 throughflow sensor
46 display/operating unit
48 data line
50 data memory
52 data line
t time
t₀ point in time
t₁ point in time
t₂ point in time
t₃ point in time
t₄ point in time
t₅ point in time
t₆ point in time
T time period
T_{A} filling time period
Q throughflow
V throughflow characteristic
Vₘₐₓ reference throughflow characteristic
Vₘᵢₙ reference throughflow characteristic

1. A method for monitoring a pressurized gas-based cleaning process in a hose filter installation, comprising:
performing a cleaning process during a predefinable time period, comprising providing a throughflow of a pressurized gas through a flow guiding element during performance of the cleaning process, determining a throughflow (Q) of the pressurized gas flow through the flow guiding element;
determining a throughflow characteristic (V) using the determined throughflow (Q) of the pressurized gas flow through the flow guiding element and monitoring the pressurized gas-based cleaning process using the throughflow characteristic (V);
flowing a pressurized gas quantity during the predefinable time period, wherein the throughflow characteristic (V) is a pressurized gas quantity that has flowed in the predefinable time period (T); and
providing the pressurized gas flow to a pressurized gas reservoir and then providing gas from the reservoir to the hose filter installation.

2. The method as claimed in claim 1, wherein
the pressurized gas quantity that has flowed in the predefinable time period (T) is a mass or a volume of the pressurized gas that has flowed in the predefinable time period through the flow guiding element.

3. The method as claimed in claim 1, further comprising:
determining the throughflow characteristic (V) by an integrating, a deriving and/or a Fourier analysis of the throughflow (Q).

4. The method as claimed in claim 1, further comprising the cleaning process further comprises at least filling the pressurized gas reservoir during a filling time period (T_{A}), by using the pressurized gas flow, and
determining the throughflow (Q) of the pressurized gas flow during, and the predefinable time period (T) which lies within the filling time period (T_{A}).

5. The method as claimed in claim 1, further comprising the monitoring comprises comparing the determined throughflow characteristic (V) with at least one predefined reference throughflow characteristic (Vₘₐₓ, Vₘᵢₙ).

6. The method as claimed in claim 5, further comprising during the monitoring, issuing an error message if the determined throughflow characteristic (V) meets a predefined condition with regard to the reference throughflow characteristic (Vₘₐₓ, Vₘᵢₙ).

7. The method as claimed in claim 1, further comprising generating at least one pressure surge during the cleaning process.

8. The method as claimed in claim 5, further comprising, detecting a hose filter installation defect by comparing the throughflow characteristic (V) with the at least one predefined reference throughflow characteristic (Vₘₐₓ, Vₘᵢₙ), which represents an intact hose filter installation.

9. The method as claimed in claim 1, further comprising performing the method in a plurality of the cleaning processes, comprising determining the throughflow characteristic (V) in several of the plurality of cleaning processes respectively, and using the determined throughflow characteristics (V) to perform a trend analysis to establish at least one trend model.

10. The method as claimed in claim 9, comprising early detecting of a hose filter installation defect, by using the at least one trend model and determining how many of the cleaning processes may be carried out until a hose filter installation defect occurs.

11. A monitoring system for a hose filter installation, comprising:
a flow guide element for conducting a throughflow of a pressurized gas;
at least one throughflow sensor located and configured for determining a throughflow (Q) of a pressurized gas flow through the flow guide element, the throughflow sensor is a volume flow sensor or a mass flow sensor; and
a control unit located and configured for controlling a pressurized gas-based cleaning process, the control unit is leading to the gas reservoir for carrying out the method as claimed in claim 1.

12. A hose filter installation comprising a plurality of hose filters and a monitoring system as claimed in claim 11.

13. The hose filter installation as claimed in claim 12, further comprising:
at least one pressurized gas reservoir; and
at least one pressurized gas line leading to the gas reservoir for supplying the gas reservoir with a pressurized gas, wherein the throughflow sensor of the monitoring system is located and configured to monitor the pressure in the pressurized gas line.

14. The hose filter installation as claimed in claim 12, further comprising a plurality of pressurized gas reservoirs and a main pressurized gas line leading to the plurality of gas reservoirs for supplying the plurality of pressurized gas reservoirs with pressurized gas, wherein the throughflow sensor of the monitoring system is located in the main pressurized gas line.

15. (canceled)

16. The method as claimed in claim 5, wherein the predefined reference throughflow characteristic has at least one of maximum and minimum throughflow.

17. The method as claimed in claim 8, wherein the hose filter installation defect comprises an intact valve, an intact pressurized gas line and/or an intact hose filter.

18. The method as claimed in claim 10, wherein the hose filter installation defect comprises an intact valve, an intact pressurized gas line and/or an intact hose filter.
